(19) United States
(12) Patent Application Publication
(10) Pub. No.: US 2006/0087319 A1
(43) Pub. Date: Apr. 27, 2006

(54) Magnetic Resonance System Response Method

(75) Inventors: Kevin Scott Kregar, Milwaukee, WI (US); Joseph James Chianese, Brookfield, WI (US); Tom Wright, Wales, WI (US)

Correspondence Address: ARTZ & ARTZ, P.C., 28333 TELEGRAPH RD., SUITE 250, SOUTHFIELD, MI, 48034, US

(73) Assignee: GE MEDICAL SYSTEMS GLOBAL TECHNOLOGY COMPANY, LLC, Waukesha, WI (US)

(21) Appl. No.: 10/904,051

(22) Filed: Oct. 21, 2004

(51) Int. Cl. G01V 3/00

(52) U.S. Cl. 324/310; 324/307

(57) ABSTRACT

An imaging system includes an exciter generating a series of radio frequency pulses for dividing a frequency band having a sampled band defined by an upper folding frequency and a lower folding frequency. The system also includes a receiver receiving and digitizing the radio frequency pulse after the radio frequency pulse has been reflected. The receiver also samples the frequency band, receives a folded radio frequency pulse appearing within the sampled band, and generates therefrom a receiver signal.

### TECHNICAL FIELD

The present invention relates generally to Magnetic Resonance (MR) systems and more particularly to a self-contained, automated method for determining a system signal response using digital sampling and alias unwrapping.

Imaging devices, such as magnetic resonance (MR) scanners, are widely used in both medical and industrial applications.

An MR scanner is both an analog signal generator and a digital acquisition system. During normal operation, the MR scanner generates a modulated radio-frequency (RF) output signal, which is used to excite an object in a magnet bore (e.g. a phantom or a patient). The object absorbs and reflects this output signal. This reflected output signal or echo is received and digitized in an MR computer and utilized to reconstruct an image of the object.

Within the scanner, the exciter generates the output signal, and the receiver receives and digitizes the reflected output signal. For testing and diagnosis, the exciter output signal is controlled in a loop-back mode via software such that the exciter output is connected directly to the input of the receiver. In other words, the exciter output drives the receiver directly rather than exciting an object in the magnet bore and producing a reflected echo. Specifically, the exciter/receiver views the system response of this combined subsystem. Resultantly, determinations of the nature of the response of an analog receiver filter (anti-aliasing filter), the nature of the exciter output response, and spurious frequencies or other noise, that may be present in this subsystem, can be made.

Current MR system cabinets include alternate implementations of the exciter and the receiver. For example, some receivers digitize the signals they receive at a very high sampling rate. This high sampling rate allows effective analysis of a bandwidth that is half the sampling rate. This limit (known as the Nyquist Criterion) forms the basis of digital signal processing theory and generates a problem for completely analyzing the exciter/receiver subsystem. In other words, the anti-aliasing filter has a specific passband that is contained within this sampled bandwidth, but the specifications for this filter also require a minimum performance in the transition band and stop band that is well beyond this sampled bandwidth limit. This minimum performance requirement must also be verified.

Current system response analysis methods include a manual test that injects frequencies across the passband and measures the results, thereby generating a plot. This is a time consuming approach, generally only used to characterize the system when the board is first designed.

An alternate system response analysis method, including the exciter characterizing the response, is currently used for measuring the band limited by the Nyquist Criterion. This utilizes the exciter to generate a single pulse having equal energy over the entire range (a sinc pulse) and then Fourier transforming the results. Although effective over this range, this method hinders the ability to see sufficiently beyond the passband of the filter to analyze the transition bands or the stop bands.

The disadvantages associated with current, system response analysis methods have made it apparent that a new technique for system response analysis is needed. The new technique should be effective over greater frequency ranges and should be adaptable for system analysis throughout the life of the system. The present invention is directed to these ends.

### SUMMARY OF THE INVENTION

In accordance with one aspect of the present invention, a method for determining system response in an imaging system includes adapting a receiver for pass thru to collect unprocessed digitized data from the output of the anti-aliasing filter, generating a first sweep of an exciter frequency from a user selected center frequency by changing an RF output frequency, sweeping the exciter frequency across an anti-alias filter, unwrapping the aliases of the exciter frequency sweep, and generating a complex output therefrom.

In accordance with another aspect of the present invention, an imaging system includes an exciter adapted to generate a series of radio frequency pulses to divide a frequency band having a digitally sampled frequency band (the passband of the filter is contained within this band) defined by an upper folding frequency and a lower folding frequency. A receiver is adapted to receive and digitize the radio frequency pulses and sample the frequency band. The receiver is further adapted to receive radio frequency pulses generated outside of the sampled band, but appearing within the sampled frequency band due to aliasing. The system compensates for the folding effect (aliasing) on the radio frequency pulses.

One advantage of the present invention is that this method allows more accurate analysis of a system over a greater bandwidth. In addition to identifying bad or marginal components and locating spurious background noise, these response plots are processed to normalize and improve system response.

A further advantage of the present invention is increased speed and ease of use. A greater bandwidth can be analyzed automatically, thereby replacing the manually intensive and invasive task of performing the same analysis with a signal generator and a spectrum analyzer.

Still a further advantage is data mining and monitoring. System response plots may be data-mined and may become a part of a data warehouse where trends in the system response can be analyzed.

Additional advantages and features of the present invention will become apparent from the description that follows and may be realized by the instrumentalities and combinations particularly pointed out in the appended claims, taken in conjunction with the accompanying drawings.

### BRIEF DESCRIPTION OF THE DRAWINGS

For a more complete understanding of the invention, there will now be described some embodiments thereof, given by way of example, reference being made to the accompanying drawings, in which:

FIG. 1 is a block diagrammatic view of an MR imaging system in accordance with one embodiment of the present invention;

FIG. 2 is a block diagrammatic view of the exciter and receiver of FIG. 1;

FIG. 3 is a graphical representation of the aliasing in accordance with one embodiment of the present invention;

FIG. 4 is a graphical representation of the aliasing in accordance with the embodiment included in FIG. 3;

FIG. 5 is a graphical representation of an ideal system response in accordance with another embodiment of the present invention;

FIG. 6 is a graphical representation of an actual composite response in accordance with another embodiment of the present; and

FIG. 7 is a block diagram of a method for operating an MR system in accordance with another embodiment of the present invention.

### DETAILED DESCRIPTION

In the following description, various operating parameters and components are described for one constructed embodiment. These specific parameters and components are included as examples and are not meant to be limiting.

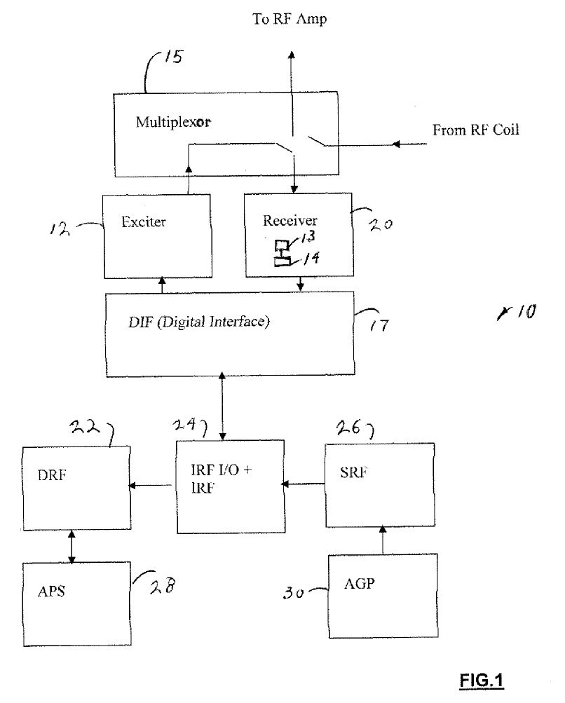

Referring now to FIG. 1, a block diagrammatic view of an exciter/receiver system 10 of a magnetic resonance (MR) system is illustrated. The system 10 includes control components, such as: an exciter 12, a receiver 20 having an anti-alias filter 13 and an analog/digital converter 14, a multiplexer 15, a Digital Interface Board (DIF) 17, a Digital Receiver Filter Board (DRF) 22, an Interface Related Function Board and input/output device (I/O) 24, a Sequencer Related Function Board (SRF) 26, a controller or Acquisition Processing System Board (APS) 28, and a secondary central processing unit under control of the APS or Application Gateway Processor Board (AGP) 30. The system 10 also includes any other MR scanner component known in the art.

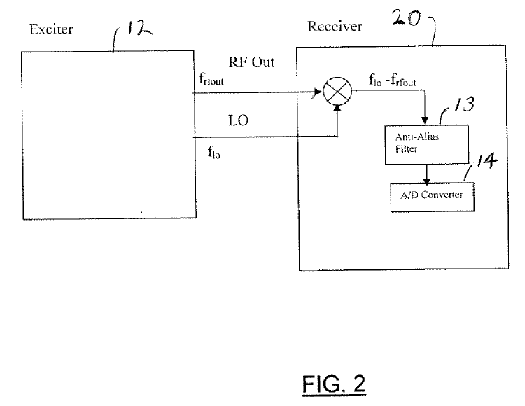

Referring to FIGS. 1 and 2, within the system 10, the exciter 12 is connected to the multiplexer 15 and the DIF 17 and is preferably digitized. The exciter 12 generates pulses of radio frequency signals. The exciter output is connected directly to the receiver 20 through the multiplexer 15.

Also within the system 10, the exciter sequence is completely cycled, which results in a swept series of synchronized pulses which are received by the receiver 20. In other words, the data that is received by the receiver 20 (and digitized) is the exciter output signal (loop back). The receiver 20 filters the data with an anti-alias filter 13 and generates an analog/digital conversion in the analog/digital converter 14. The receiver 20 is set-up for pass thru (without digital filter) to collect the unprocessed digitized data from the output of the anti-aliasing filter.

The multiplexer 15, or data selector, is a modular device that selects one of many input lines to appear on a single output line. The multiplexer 15 sends and receives analog signals from an RF coil assembly. The multiplexer 15 also receives exciter signals, which are subsequently received in the receiver 20.

The main controlling program runs on the APS 28, which controls the AGP 30, which in turn downloads the sequence which runs on the SRF 26. The sequencing data is received in the exciter 12 through the IRF/IRF I/O 24 and DIF 17.

After the generated sequencing data is received by the exciter 12, the sequence data sets up and runs the exciter 12. The actual output signal from the exciter 12 is not, however, directly the sequence data. For example, the difference could be the sequence sets up the frequency of the exciter output by writing a single value to a frequency control register (this data would be part of the playout sequence), but the actual signal out of the exciter 12 is a sine wave.

The exciter output is received by the receiver 20, demodulated, filtered, and digitized. The digitized data is received serially in the DIF 17, then in the IRF I/O and IRF 24, and then the DRF 22, which passes the data through to the main program on the APS 28, which reconstructs the response plots.

The exciter generates two outputs: RF out and LO. The LO signal is a pure sinusoid used by the receiver 20 to demodulate the incoming MR signal. In the present invention it is used to demodulate the loopback of exciter RF output to the receiver input signal. The exciter frequency is swept from a user selected center frequency for example minus 500 kHz to plus 500 kHz.

In order to analyze the exciter's output response this sweep is generated by changing the RF Out carrier frequency and LO frequencies simultaneously so that the demodulated synchronized pulse ends up in the center of the anti-alias filter band on every pulse.

For reconstruction of phase and magnitude plots of the exciter's output from sweep data, it is important to note that no frequency unwrapping is needed because delta frequency between RF Out and LO is constant. Because the sinc pulse ends up centered in the sampled band, it is properly shifted in the exciter output reconstruction. Exciter pulses may be phase synchronous across sweep in order to reconstruct accurate phase. Optionally, the phase offsets between every pulse can be analyzed and subtracted. One embodiment includes repeating the Exciter analysis sweep and averaging the results. From either of the above methods, the exciter complex output response is generated.

An alternate embodiment includes sweeping the exciter frequency from a user selected center frequency minus for example, 500 kHz to plus 500 kHz to analyze the combined system response of the exciter and receiver. This sweep is generated by changing RF Out carrier Frequency only. The result sweeps across the anti-alias filter and must be unwrapped as described in patent disclosure. This second exciter sweep is repeated and the results are then averaged.

The complex system response of 0034 is divided by the complex exciter response of 0033 to generate the receiver response. The complex frequency domain data may then be filtered to smooth noise and provide a basis to measure noise (white and impulsive) by subtracting the smoothed response or by otherwise accounting for the occurrence of spurious frequencies and white noise in the analysis.

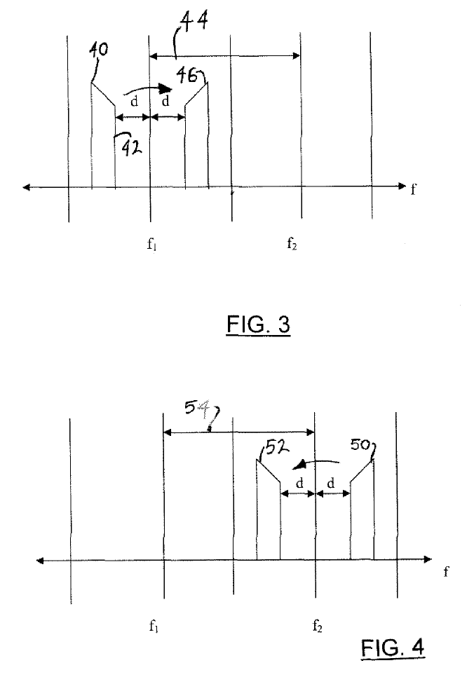

Referring to FIGS. 3 and 4, graphical representations of the aliasing of the present invention are illustrated. In FIG. 3, the exciter 12 generates a pulse 40 that has frequency domain characteristics with the right edge 42 of the pulse 40 located at a distance of d Hertz from the folding frequency f₁ (Note that either end of the sampled frequency band 44 is defined by an upper and lower “folding frequency” here designated f₁ and f₂). Under these conditions the frequency pulse 40 appears on the digitized signal as reflected or folded over the folding frequency from left to right, such that it appears as the reflected pulse 46. Similarly, if the exciter 12 generates a pulse 50 above the upper folding frequency f₂, as in FIG. 4, it folds to appear as pulse 52 within the sampled frequency band 54.

The system 10 analyzes a high frequency band utilizing several echoes that divide the examined bandwidth (equally in the present embodiment, however, alternate embodiments include various proportions). The system 10 analyzes almost any frequency response and is not limited by the number of echoes used.

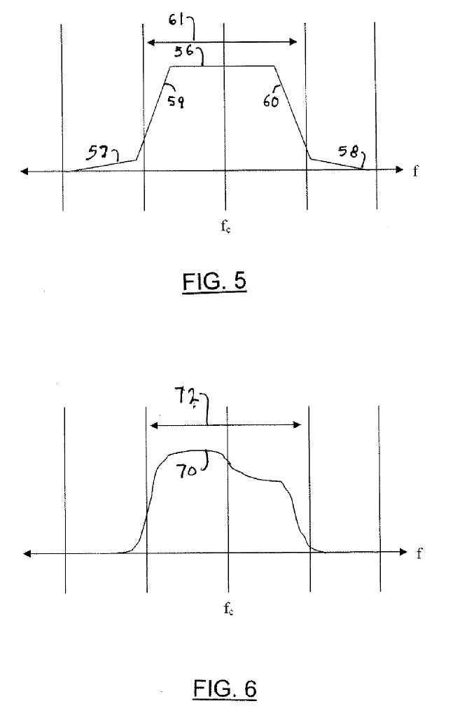

Referring to FIG. 5, an ideal system magnitude response 56, including two stop bands 57, 58, two transition bands 59, 60, and a sampled bandwidth 61 under examination by the system 10, is illustrated.

In contrast to the ideal magnitude response of FIG. 5, FIG. 6 illustrates a composite magnitude response 70 generated through operation of the system 10. In other words, each individual exciter generated echo is constructed and windowed to have an almost ideal pulse shape in the frequency domain. After this pulse passes thru the system 10 it takes the shape of the frequency response of the portion of the spectrum stimulated thereby. Each one of these echoes is Fourier Transformed, and the relevant points are used to build the composite response 70 within the sampled frequency band 72 and within the regions lying beyond this band 73 and 74.

One skilled in the art will realize that a phase response is also generated by the system 10, however the magnitude response was included herein for illustration.

To prevent persistent background noise from contaminating the results, the sampled bandwidth without excitations is analyzed. This is subtracted from (or otherwise accounted see 0042) the sampled bandwidth having excitations so noise will not be construed as the system response. Substantially eliminating background noise causes the shape of the composite response 70 to approach the shape of the actual response.

Important to note is that asynchronous background noise such as spurious frequencies cannot always be completely subtracted, but the position of the spurious frequencies in the background noise can be noted so the automated analysis does not detect a failure in response due to this noise, but may alternatively report the presence of the noise peaks usually caused by nearby noise sources or failing components.

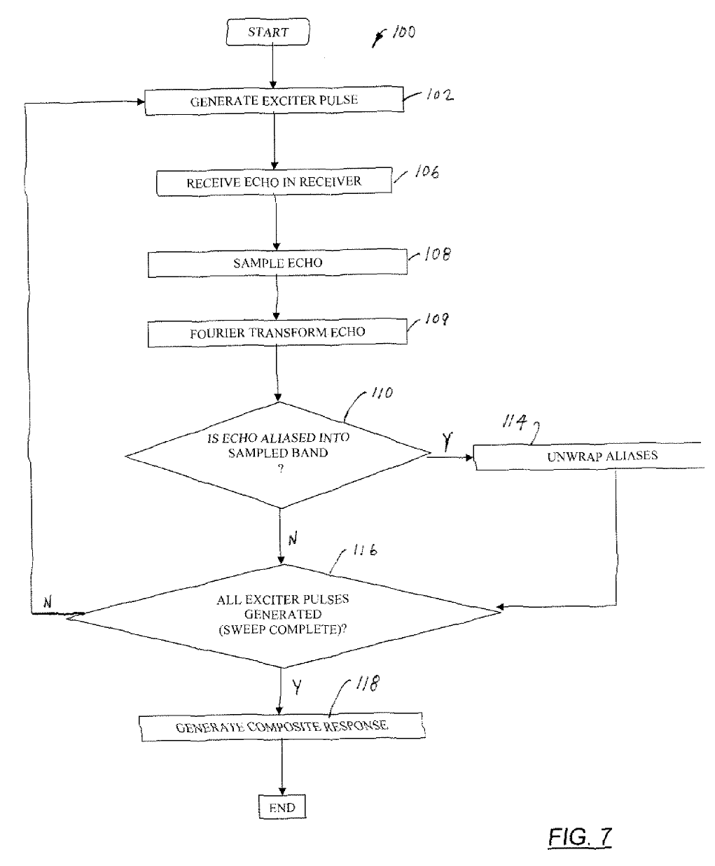

Referring to FIG. 7, a block diagram of a method 100 for operating an MR system is illustrated. Logic starts in operation block 102 where the exciter 12 is activated by an MR operator through, for example, a control panel, and the exciter 12 generates frequency pulses.

In operation block 106, echoes from the exciter 12 are received in the receiver 20 through the multiplexer 15. If the frequency is outside the sampled band in the analog signal, then it is aliased into the sampled bandwidth when it is digitized by the receiver 20.

In operation block 108, the receiver 20 samples a bandwidth, and the echoes divide the bandwidth.

In operation block 109, the echoes are Fourier transformed within the receiver 20 to generate a plurality of points.

In inquiry block 110, a check is made whether the echo is aliased within the sampled bandwidth.

For a positive response, in operation block 114, the receiver 20 unwraps the Fourier transform.

Subsequently, inquiry block 116 activates either in response to operation block 114 or a negative response to inquiry block 110. In inquiry block 116, the echo is moved to the respective place in the composite response, and a check is made whether all the exciter pulses have been generated and whether the sweep is complete. For a negative response, operation block 102 reactivates, and another echo in the sweep is processed.

Otherwise, in operation block 118, a composite response is generated from the plurality of points.

Otherwise, in operation block 118, a composite response is generated from the plurality of points.

In operation, a method for determining system response in an imaging system includes generating a plurality of radio frequency pulses and dividing a bandwidth into a plurality of respective sections with the plurality of radio frequency pulses. The radio frequency pulses are swept across the bandwidth. Respective widths of each of the plurality of radio frequency pulses are set such that the plurality of pulses overlap sufficiently to prevent notches from forming in the composite response.

Additionally, aliases occurring when any of the plurality of radio frequency pulses is outside of the bandwidth are unwrapped. The composite response is constructed from Fourier transforms of the plurality of radio frequency pulses and displayed on a monitor. In one embodiment, the bandwidth without excitation is subtracted from the plurality of radio frequency pulses with the bandwidth having excitation from the plurality of radio frequency pulses to analyze and remove system noise. Alternate embodiments do not include the aforementioned subtracting step in situations where analysis of the position of the spurious noise generates useful information.

Also, as mentioned before, an alternate embodiment of the system 10 includes directing the RF output thru a coil and picking up the reflected echo.

From the foregoing, it can be seen that there has been brought to the art a new exciter/receiver system 10. It is to be understood that the preceding description of the preferred embodiment is merely illustrative of some of the many specific embodiments that represent applications of the principles of the present invention. Numerous and other arrangements would be evident to those skilled in the art without departing from the scope of the invention as defined by the following claims.

What is claimed is:

1. A method for determining system response in an imaging system comprising:
adapting a receiver for pass thru to collect unprocessed digitized data;
generating a first sweep of an exciter frequency from a user selected center frequency by changing an RF output frequency sweeping said exciter frequency across an anti-alias filter;
unwrapping said exciter frequency; and
generating a complex output.

2. The method of claim 1 further comprising generating a second exciter sweep and averaging results of said second exciter sweep with results of said first sweep.

3. The method of claim 1, wherein generating said first sweep further comprises generating said first sweep from a user selected center frequency by changing RF output and LO frequencies simultaneously;
The method of claim 1 further comprising dividing a system response by said complex output; and
generating a receiver response.

4. The method of claim 1 further comprising filtering said complex output; and
generating a smoothed response.

5. The method of claim 5 further comprising subtracting said smoothed response from said complex output thereby generating a basis to measure noise.

6. The method of claim 1 further comprising generating a plurality of radio frequency pulses.

7. The method of claim 1, wherein generating said complex output further comprises Fourier transforming said exciter frequency.

8. The method of claim 1 further comprising displaying said complex output.

9. The method of claim 1 further comprising transmitting said exciter frequency to a patient bore;
reflecting said exciter frequency; and
receiving said exciter frequency in a receiver.

10. An imaging system comprising:
an exciter adapted to generate a first radio frequency pulse to divide a frequency band having a sampled band defined by an upper folding frequency and a lower folding frequency; and
a receiver adapted to receive and digitize said radio frequency pulse after said radio frequency pulse has been reflected, said receiver further adapted to sample said frequency band, said receiver further adapted to receive a folded radio frequency pulse appearing within said band and generate therefrom a receiver signal.

11. The system of claim 11, wherein said exciter is further adapted to generate a plurality of radio frequency pulses.

12. The system of claim 11, wherein said receiver is further adapted to set respective widths of each of said plurality of radio frequency pulses such that said plurality of pulses overlap sufficiently to prevent notches from forming in said composite frequency response.

13. The system of claim 11 further comprising a central controller (APS); a secondary controller (AGP); and a sequencer (SRF), wherein said APS comprises logic adapted to control said AGP, which is adapted to download a sequence adapted to run on said SRF, wherein said sequence is received in said exciter, which is controlled in response thereto.

14. A method for determining system response in an imaging system comprising:
generating a plurality of radio frequency pulses;
dividing a bandwidth into a plurality of respective sections with said plurality of radio frequency pulses;
sweeping said plurality of radio frequency pulses across said bandwidth;
unwrapping a first alias occurring when at least one of said plurality of radio frequency pulses is outside a of said bandwidth; and
generating a composite response from said plurality of radio frequency pulses.

15. The method of claim 15 further comprising subtracting said bandwidth without excitation from said plurality of radio frequency pulses with said bandwidth having excitation from said plurality of radio frequency pulses.

16. The method of claim 15 further comprising setting respective widths of each of said plurality of radio frequency pulses such that said plurality of pulses overlap sufficiently to prevent notches from forming in said composite response.

17. The method of claim 15, wherein generating said composite response further comprises Fourier transforming said at least one of said plurality of radio frequency pulses.

18. The method of claim 15 further comprising displaying said composite response.
